(19) United States
(12) Patent Application Publication
(10) Pub. No.: US 2018/0180087 A1
(43) Pub. Date: Jun. 28, 2018

(54) FASTENER SEALING MATERIAL AND METHOD

(71) Applicant: Nylok LLC, Macomb, MI (US)

(72) Inventors: Jeffrey M. Stupar, West Dundee, IL (US); Pakkatorn Jaroenwatthanawinyoo, Chicago, IL (US)

(21) Appl. No.: 15/844,985

(22) Filed: Dec. 18, 2017

Related U.S. Application Data
(60) Provisional application No. 62/437,967, filed on Dec. 22, 2016.

(51) Int. Cl. F16B 39/22; F16B 33/00; B05D 3/06; B05D 3/14; C08L 33/08; C09J 133/08

(52) U.S. Cl. CPC F16B 39/225; F16B 33/004; B05D 3/067; F16B 19/008; C08L 33/08; C09J 133/08; C09J 2433/00; B05D 3/142

(57) ABSTRACT

A fastener sealing material for application to miniature and sub-miniature fasteners is formulated from a liquid applied acrylate material. The liquid applied acrylate material is cured using an ultraviolet or LED light source, without the use of heat. When applied to a fastener, the fastener sealing material can form a locking material for the fastener. A method of making a fastener with a sealing material thereon is also disclosed.

### CROSS-REFERENCE TO RELATED APPLICATION DATA

This application claims the benefit of and priority to Provisional U.S. Patent Application Ser. No. 62/437,967, filed Dec. 22, 2016, entitled “Fastener Sealing Material and Method”, the disclosure of which is incorporated herein in its entirety.

### BACKGROUND

The present disclosure relates to a material for sealing fasteners, such as sub-miniature screws, in place to, for example, prevent the ingress of water, moisture and dust, into an assembly in which the fastener is used, and a method for applying such a sealing material.

Fastener are used, for example, to secure components to one another. In one example, fasteners are used to secure components within electronic devices, such as smart phone, tablets, pads and the like. As the devices get smaller, so too are the components and the fasteners to secure the components getting smaller. And, although devices are getting smaller, the need to maintain the components free from water, moisture and dust has not changed. In fact, many such smaller devices require an even higher level of assurance that components are well isolated from the environs in order to properly function.

While there are known sealing materials, these materials are provided in powdered form, such as nylon 11 powder, and require that the fasteners are heated, before or after application of the material, in order for the material to melt and flow around the underside of the head of the fastener. These materials and methods of applying a sealing material work well for larger fasteners. However, for miniature and sub-miniature fasteners—fasteners having head diameters of 2.0 mm (M2.0) to 3.0 mm (M3.0) and 0.8 mm (M0.8) to 1.4 mm (M1.4), respectively, which fasteners have shank diameters of about ½ the head diameter, these materials and methods can pose problems, and the rejection rate can be as high as 10-20 percent due to overspray issues. This rejection rate is significantly higher than what is acceptable, especially in that the fasteners can only be reworked one time, e.g., the material can only be removed and the sealing material reapplied only one time.

Accordingly, there is a need for a material that can be used to seal miniature and sub-miniature fasteners in an assembly and provide an acceptable seal against environmental conditions such as water, moisture, dust and the like. Desirably, such a material is applied to the fasteners in liquid form and can readily flow around the underside of the fastener head (the bearing surface), as desired, to provide a complete covering of the underside of the head, without overspray. More desirably still, such a material rapidly cures and a method of application is a non-heat or minimally heat-applying and producing process. Still more desirably, such a material permits reuse of the fasteners—that is the fastener can be applied and removed and reapplied with the sealing material maintaining its sealing properties.

### SUMMARY

Various embodiments of the present disclosure provide a fastener sealing material for application to miniature and sub-miniature fasteners. The sealing material is formulated from a liquid applied acrylate material, such as an acrylated urethane, and acrylated polyester and the like. The liquid applied material is cured using an ultraviolet or LED light source and without the use of heat.

In an embodiment, a viscosity of the material is less than about 1500 centipoise. The viscosity of the material can be about 500-1500 centipoise. Such a viscosity allows the sealant to, if desired, somewhat wick up onto the shank of the fastener. This geometry may be required in certain applications. In other applications wicking is not required or desired.

A super hydrophobic material can be included as an additive. Other additives include a suitable photoinitiator, and can include a pigment present in an amount so as to not impede curing the material, a flow modifier and a heat resistive additive material.

In an embodiment, the material cures on the fastener in no more than about 2-15 seconds, preferably about 2-10 seconds and more preferably about 2-5 seconds when subject to ultraviolet or LED light and at a temperature of no more than about 66 deg.C. (about 151 deg.F), and preferably at about room temperature 25 deg.C. (about 77 deg.F). Fasteners with the sealing material thereon retain their sealing characteristics following multiple installations and removals. For example, fasteners with the sealing material thereon retain their sealing characteristics following at least three installations and removals.

In some embodiments, when applied to a fastener, the fastener sealing material wicks on to a portion of a shank of the fastener. In other embodiments, the sealing material does not wick up on a portion of the fastener shank. The fastener sealing material may also, when applied to a fastener, form a locking material for the fastener. A method of making a fastener with a sealing material thereon is also desired.

Other aspects, objectives and advantages will become more apparent from the following detailed description when taken in conjunction with the accompanying drawings.

### BRIEF DESCRIPTION OF THE DRAWINGS

FIGS. 1A-1H are photographs of fasteners having a known, prior art sealing material applied thereto;

FIG. 2 is a photograph of an M1,4 fastener bearing surface having an embodiment of the present fastener sealing material applied thereto, illustrating the flow coating of the underside of the fastener head;

FIGS. 3A and 3B are photographs of the underside or under head (bearing) surface of an M1.4 fastener prior to application of the present fastener sealing material (FIG. 3A) and after application of the fastener sealing material (FIG. 3B);

FIGS. 4A-4B are photographs of the top side of an M1.0 fastener before and after application of the present sealing material;

FIG. 4C is a photograph of the underside of the head and a portion of the shank of a 4-40 sized fastener following application of the present fastener sealing material;

FIG. 5 is a photograph of a submergence test structure;

FIGS. 6A and 6B are photographs of a test chamber;

FIGS. 7A and 7B are photographs showing the ability of the material to wick up onto the shank of a fastener in which FIG. 7A illustrates a fastener prior to application of the present sealing material and FIG. 7B illustrates a fastener in which the sealing material is applied to the fastener and shows the material wicking onto a portion of the shank of the fastener; and

FIG. 8 is a photograph of a fastener with an original sealant material and blue patch (locking mechanism/material).

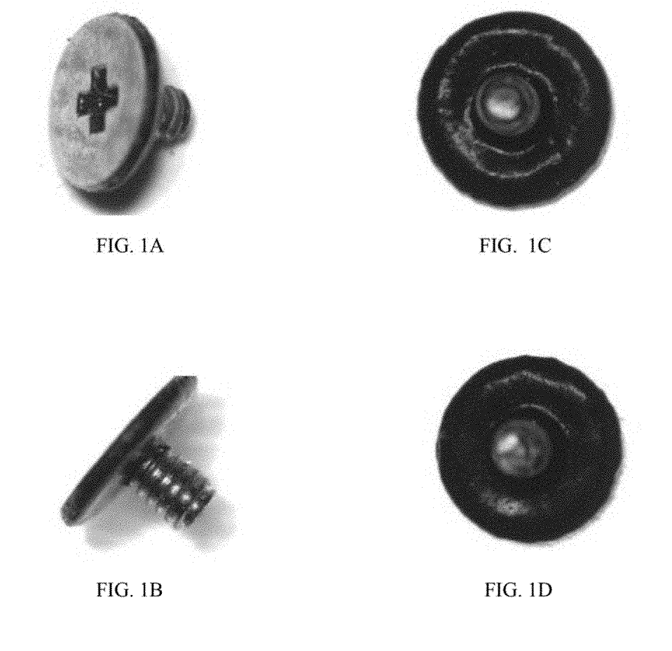

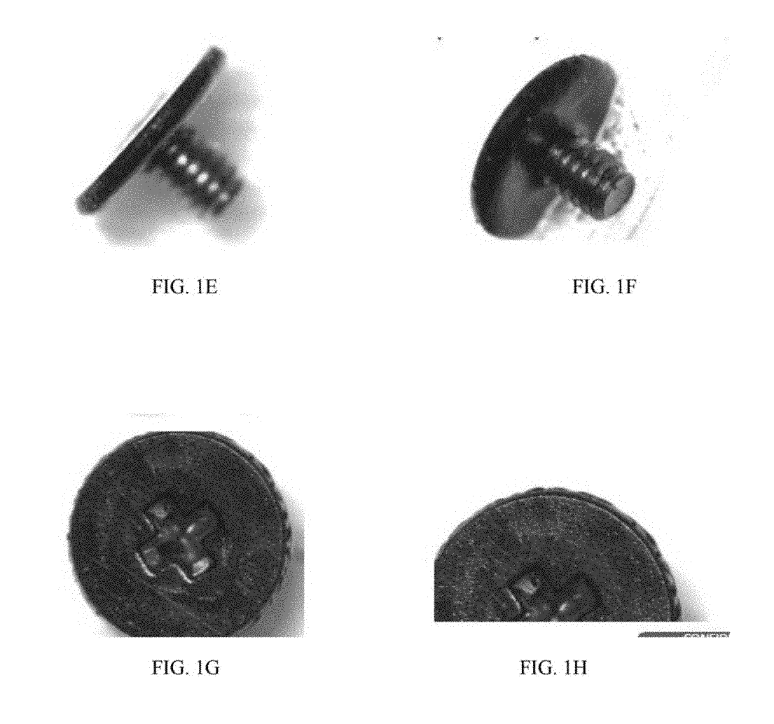

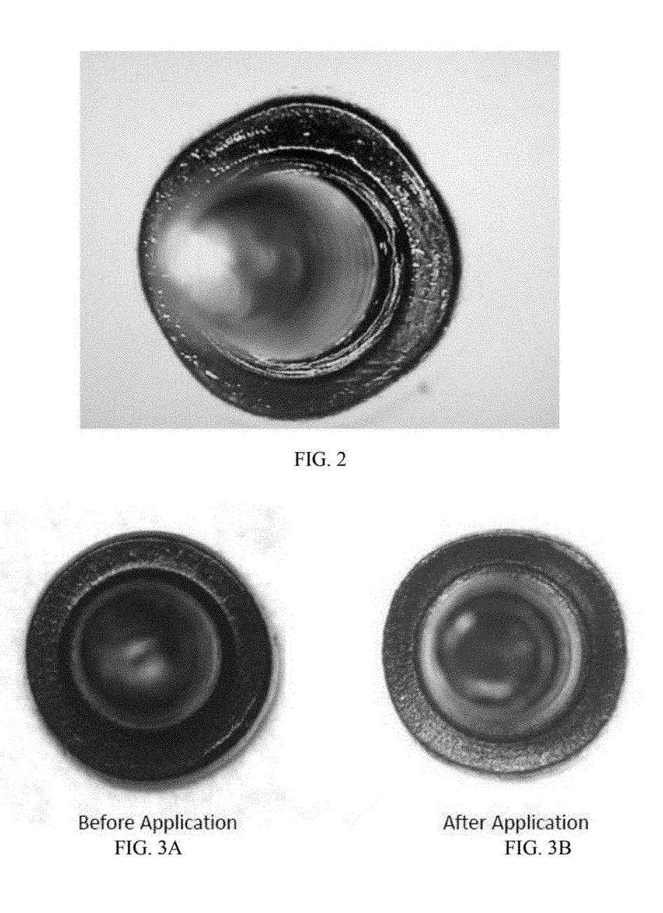

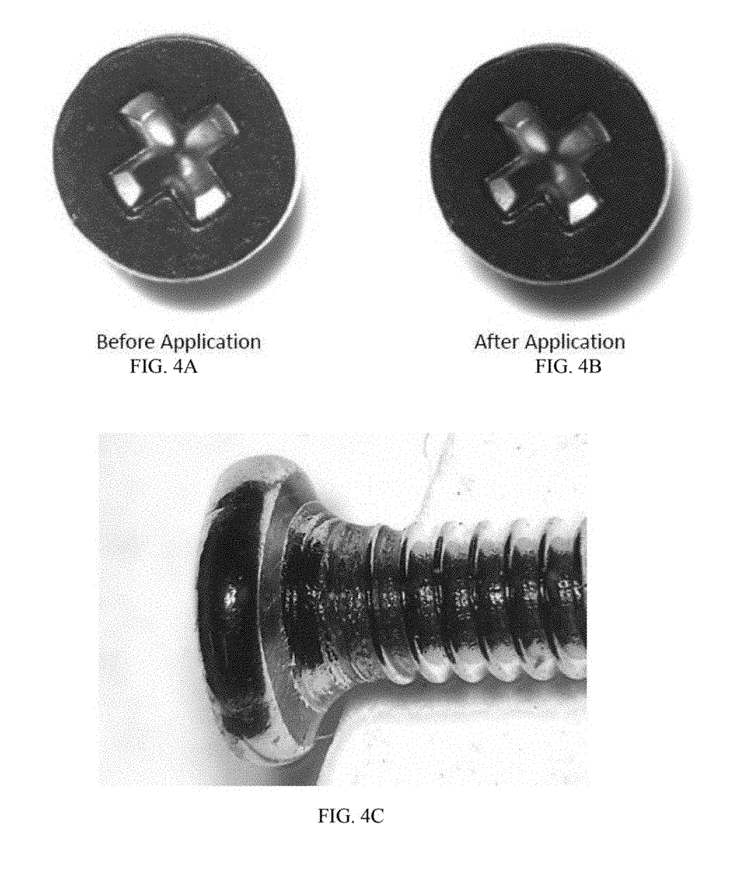

These and other features and advantages of the present disclosure will be apparent from the following detailed description, in conjunction with the appended claims.

### DETAILED DESCRIPTION

While the present disclosure is susceptible of embodiments in various forms, there is described a presently preferred embodiment with the understanding that the present disclosure is to be considered an exemplification and is not intended to limit the disclosure to the specific embodiment illustrated.

The need to provide a seal between fasteners and components that are being fastened is paramount and is of particular importance in today's electronic devices. This need is exaggerated by the constant reduction in size of the components within these devices. Known materials are not adequate for sub-miniature fasteners which are fasteners having head diameters of 0.8 mm (M0.8) to 1.4 mm (M1.4) and shank diameters of about ½ the head diameter, nor may the materials be adequate for miniature fasteners, which are those fasteners that have head diameters of about 2.0 mm (M2.0) to 3.0 mm (M3.0). And, it is anticipated that sub-miniature fasteners may in the future become even smaller.

Accordingly, an embodiment of a present sealing material includes as a principal material, an acrylate such as acrylated materials, for example, acrylated polyesters, aliphatic and aromatic acrylated urethanes and the like, such as an acrylated urethane, for example, that which is available from Dymax Corporation under product names MULTI-CURE®6-621 and 6-630, and that which is available from Advanced Adhesive Systems, Inc. of Newington, Conn. A super hydrophobic material additive may be added to the acrylate material, such as to an acrylated urethane to further resistance to water and moisture.

In one embodiment it was found that a formulation of about 75-99 wt. percent of an acrylated urethane and about 1-24 wt. percent of the super hydrophobic material form a suitable formulation for application to miniature and sub-miniature fasteners. In an embodiment, additional additives such as pigments, for example a black pigment, flow modifiers and anti-counterfeiting agents may be added in relatively small amounts to the formulation. A curing agent, such as an appropriate photoinitiator for curing the material by, for example exposing the material applied to the fastener to UV or LED light, is present in the material. Flow modifiers may or may not be needed if the viscosity of the sealing material is such that it flows properly and as desired, dependent upon the fastener size, material coating thickness and wicking characteristics desired and the like. Heat resistant additives may also be incorporated into the formulation to prevent additional chemical and/or physical changes to the material after curing. It will be appreciated that any additives used should not be of the type to interfere with the UV or LED curing step.

Advantageously, it has been found that such a formulation provides a low viscosity liquid material that better lends itself to high speed application with fewer rejects. Such a material permits high speed application onto small screws due to the low viscosity, e.g., about 500-1500 centipoise, which makes it only slightly more viscous than water.

Moreover, such materials can be cured in a relatively short period of time without the use of heat. Indeed, the material can be cured using an ultraviolet light source (at the proper wavelength of ultraviolet light) or an LED light source, as appropriate, and based upon the type of photo initiator used. It has been found that the materials can be cured, on miniature and sub-miniature fasteners in about 2-15 seconds, and preferably in about 2-10 seconds and preferably still in about 2-5 seconds without the use of heat. Unlike known sealing materials which require application to heated fasteners or heating after application to the fasteners, the present material cures in about 2-15, or 2-10 or 2-5 seconds at a temperature of less than about 66 deg.C. (about 151 deg.F), and preferably at about room temperature 25 deg.C (about 77 deg.F). Thus curing can be carried out without the need for induction or other types of heating.

It has been observed that fasteners that have sealing materials such as nylon applied using heating methods that may require temperatures as high as 375 deg.F to 450+ deg.F in order to melt the nylon, may exhibit blistering of the decorative finishes on the screws.

Moreover, unlike known sealing materials that are applied as powders, the present sealing material is applied as a liquid. As such, and because of the low viscosity, when the material is applied to a fastener, for example, the underside of the head of a fastener (e.g., the bearing surface), the material can be formulated to readily flow around the entirety of the underside of the head, thus providing a completely wetted surface, ready for curing. It will be appreciated that the material can be formulated with, for example, flow additives such that it is slightly more resistant to flow and does not wick up to the bearing surface. Such a formulation may be advantageous in applications such as when the fastener threads extend fully up to the underside of the head or the bearing surface. Furthermore, the material includes no solvents, no halogens, no polyvinyl chlorides (PVCs), no REACH substances of very high concern (REACH SVHCs), no phthalates, no bisphenol A (BPA) and is RoHS (restriction of hazardous substances) compliant.

It has been found that fasteners having the present sealing material exhibit superior performance in sealing against water and that the cured material has outstanding adhesion to metals. It has also been found that fasteners having the present sealing material exhibit excellent adhesion to steel and superior durability for multiple installations; that is the fasteners can be installed and removed multiple times and the material remains in place, with a high degree of integrity, such that the sealing properties of the material-applied fasteners are retained. It was also observed that the present sealing material exhibited good water resistance and high temperature, e.g., heat resistance, up to about 300 deg.F (about 150 deg.C).

Adhesion performance of the sealant to the fastener can be further enhanced so that the fastener and sealant retain their characteristics following multiple installations. It has been found that enhanced performance after initial testing was exhibited when the fasteners were subjected to a plasma treatment process prior to application of the sealant to the fasteners. These plasma pre-treated fasteners exhibited a significant reduction in sealant failures after multiple installations and removals. Adhesion performance can also be enhanced using internal (chemical solutions) additives and treatments. Suitable treatments include treatments with adhesion promoters.

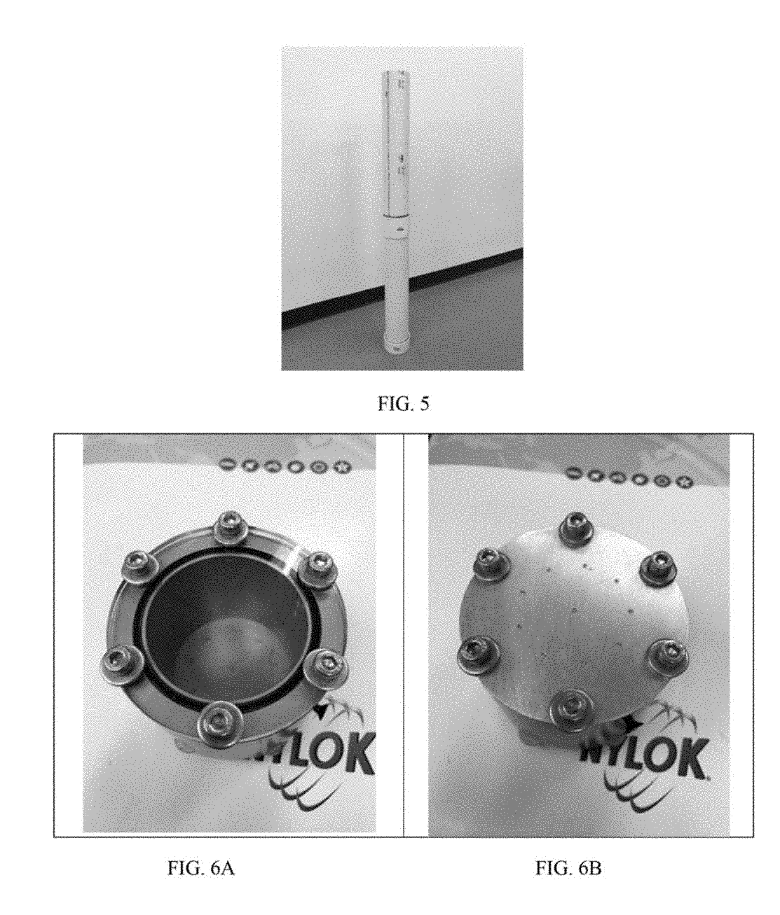

Tests were conducted using the present sealing material on M1.0 fasteners to determine the effectiveness of the present sealing material. A testing device was constructed that included a submergence test structure or tank (FIG. 5) and a submergence test chamber (FIGS. 6A and 6B) in which 10 M1.0 fasteners having the sealing material applied thereto secured a transparent plastic plate to a steel chamber. In each of the tests, the sealed chamber was submerged in a column of water to a depth of 1 meter for a period of time minutes. Four types of tests were conducted.

In the first test, the fasteners were installed and the chamber submerged for a period of 30 minutes. After the chamber was submersed for 30 minutes, the chamber was removed from the tank and examined from the bottom, through the plastic cover, to confirm that it was free of leaks. After the submergence test, the chamber was placed in an oven at about 195 deg.F (90 deg.C) for 10 minutes until the surface reached about 122 deg.F (50 deg.C). The chamber was then removed from the oven and a small amount of water was dripped on to the plastic cover. After 45 seconds, the water was wiped off of the plastic cover to confirm that the chamber was free of any signs of water vapor or droplets.

In the second test, the fasteners were installed and removed four times to show durability over multiple installations and were subsequently submergence tested. Following the final installation, the chamber was submersed to a depth of about 1 meter depth for a period of 30 minutes. Following submergence, the chamber was removed from the tank and examined from the bottom, through the plastic cover, to confirm that it was free of leaks. Subsequently, the chamber was placed into an oven at about 195 deg.F (90 deg.C) for 10 minutes until the test fixture reached about 122 deg.F (50 deg.C). The testing device was then removed from the oven and a small amount of water was dripped on to the plastic cover. After 45 seconds, the water was wiped off of the plastic cover to confirm that the chamber was free of any signs of water vapor or droplets.

In the third test, the fasteners were tightened onto the plate and the chamber was conditioned, e.g., placed in a mechanical oven, at a temperature of about 175 deg.F (80 deg.C) for a period of 24 hours. After conditioning, the chamber was allowed to return to room temperature before the submergence test was conducted. The chamber was then submersed to a depth of about 1 meter for about 30 minutes. After submergence, the chamber was removed from the tank and examined from the bottom, through the plastic cover, to confirm that it was free of leaks. Subsequently, the chamber was placed into an oven at about 195 deg.F (90 deg.C) for a period of 10 minutes until the surface reached about 122 deg.F (50 deg.C). The chamber was then removed from the oven and a small amount of water was dripped on to the plastic over. After 45 seconds, the water was wiped off of the plastic cover to confirm that the chamber was free of any signs of water vapor or droplets.

In another test, the fasteners were tightened onto the plate and the chamber was conditioned, e.g., placed in a mechanical oven, at a temperature of about 250 deg.F (120 deg.C) for a period of 3 hours. After conditioning, the chamber was allowed to return to room temperature before the submergence test was conducted. The chamber was then submersed to a depth of about 1 meter for about 30 minutes. After submergence, the chamber was removed from the tank and examined from the bottom, through the plastic cover, to confirm that it was free of leaks. Subsequently, the chamber was placed into an oven at about 195 deg.F (90 deg.C) for a period of 10 minutes until the surface reached about 122 deg.F (50 deg.C). The chamber was then removed from the oven and a small amount of water was dripped on to the plastic cover. After 45 seconds, the water was wiped off of the plastic cover to confirm that the chamber was free of any signs of water vapor or droplets.

In still another test of the fasteners in which the fasteners were plasma pretreated and the material from Advanced Adhesive Systems, Inc. was used, following application and curing of the material, the fasteners were installed and removed three times at room temperature. The fasteners and plates were then tested at 8 psi and 16 psi for 60 seconds and inspected for leakage. No leakage was observed. The samples were then heated in an oven at 120 deg.C for 3 hours and then retested at 8 psi and 16 psi for 60 seconds and inspected for leakage. No leakage was observed. Adhesion of the sealant material to the fasteners was also checked, and the material could not be removed from the fasteners' bearing surfaces. A similar test was conducted in which the same protocol was followed except that the fasteners were heated in an oven at 80 deg.C for a period 12 hours rather than 3 hours at 120 deg.C.

The results of each test showed that no condensation or leakage was observed and as such, it was determined that there was no moisture inside the chamber and no water infiltration into the chamber.

It is also contemplated that sealing materials can be formulated for use on larger fasteners. For example a formulation for larger fasteners may use as a principal material, an acrylate or acrylated urethane, such as that available from Dymax Corporation under product names DUAL-CURE 9481-E and 9482, or the above-referenced material by Advanced Adhesive Systems. It has been found that these acrylated urethanes have high water, chemical and heat resistance while retaining the advantageous characteristics of superior performance in sealing against water and exhibited outstanding adhesion to metals. In addition, use of these materials provides a sealing material that exhibits excellent adhesion to steel and superior durability for multiple installations with a high degree of integrity such that the sealing properties of the material-applied fasteners are retained.

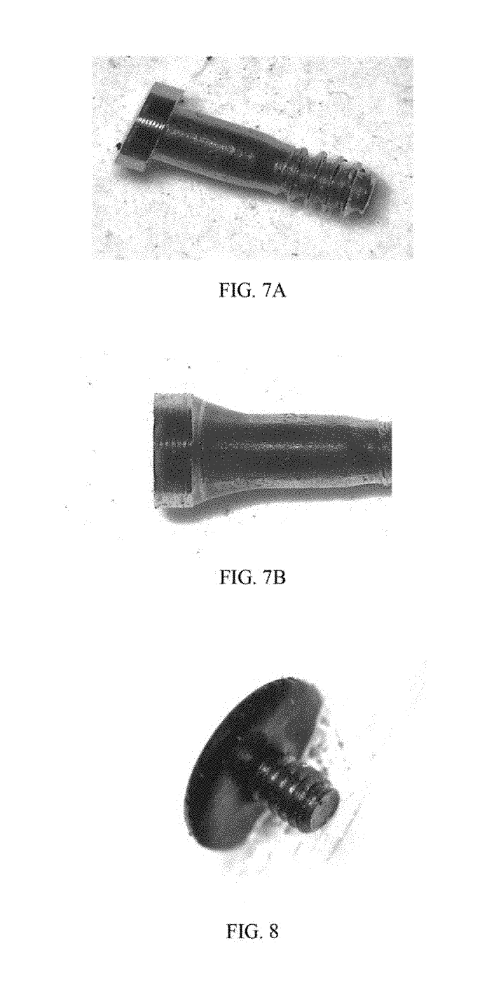

As noted above, one advantageous characteristic of an embodiment of the present sealing material is its ability to wick up onto a portion of the fastener shank. FIGS. 7A and 7B are photographs showing the ability of an embodiment of the material to wick up onto the shank of a fastener in which FIG. 7A illustrates a fastener prior to application of the present sealing material and FIG. 7B illustrates a fastener in which the embodiment of the sealing material is applied to the fastener and shows the material wicking onto a portion of the shank of the fastener. Such wicking may be desired or required in certain applications.

Moreover, due to its great adhesion to steel fasteners and its comparable hardness compared to nylon 11 (which is currently used as a mechanical locking mechanism/material for fasteners, see, for example, FIG. 8), the present sealing material serves multiple functions. As such, in addition to its use as a sealing material, it can also function to lock a fastener in place, without the need for secondary processing to, for example, apply a locking patch (e.g., a nylon 11 patch), thereby resulting in additional productivity improvements and reducing the complexity and steps required in manufacturing.

A method of making a fastener with a sealing material thereon includes the steps of applying a liquid applied acrylate material to the fastener and curing the liquid applied acrylate material using an ultraviolet or LED light source and without the use of heat. The method can include pretreating the fastener with a plasma treatment. The liquid applied acrylate material can be any of the above-described materials, including a suitable photoinitiator, and other additives such as a pigment present in an amount so as to not impede curing the material, a flow modifier and a heat resistive additive material. A super hydrophobic material may also be included as an additive.

In the present disclosure, the words “a” or “an” are to be taken to include both the singular and the plural. Conversely, any reference to plural items shall, where appropriate, include the singular.

All patents and published applications referred to herein are incorporated by reference in their entirety, whether or not specifically done so within the text of this disclosure.

It will also be appreciated by those skilled in the art that the relative directional terms such as sides, upper, lower, top, bottom, rearward, forward and the like are for explanatory purposes only and are not intended to limit the scope of the disclosure.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

What is claimed is:

1. A fastener sealing material for application to miniature and sub-miniature fasteners, comprising:
a liquid applied acrylate material, the liquid applied acrylate material cured using an ultraviolet or LED light source and without the use of heat.

2. The fastener sealing material, wherein a viscosity of the material is less than about 1500 centipoise.

3. The fastener sealing material of claim 2, wherein the viscosity of the material is about 500-1500 centipoise.

4. The fastener sealing material of claim 1, wherein the acrylate material is one or a combination of acrylated urethanes and acrylated polyesters.

5. The fastener sealing material of claim 1 including a super hydrophobic material.

6. The fastener sealing material of claim 1 including a photoinitiator.

7. The fastener sealing material of claim 1 including a pigment, the pigment present in an amount so as to not impede curing the material.

8. The fastener sealing material of claim 1 including a flow modifier.

9. The fastener sealing material of claim 8, wherein the flow modifier decreases the viscosity of the sealing material.

10. The fastener sealing material of claim 8, wherein the flow modifier increases the viscosity of the sealing material.

11. The fastener sealing material of claim 1 including a heat resistive additive to reduce further curing of the material after it is cured and when subjected to elevated temperatures.

12. The fastener sealing material of claim 1 wherein the material cures on the fastener in no more than about 2-15 seconds when subject to ultraviolet or LED light.

13. The fastener sealing material of claim 12 wherein the material cures on the fastener in no more than about 2-5 seconds when subject to ultraviolet or LED light.

14. The fastener sealing material of claim 12 wherein the material cures on the fastener at a temperature of no more than about 151 deg.F.

15. The fastener sealing material of claim 1 wherein the fastener with the sealing material thereon retains its sealing characteristics following multiple installations and removals.

16. The fastener sealing material of claim 15 wherein the fastener with the sealing material thereon retains its sealing characteristics following at least three installations and removals.

17. The fastener sealing material of claim 1 wherein when applied to a fastener, the fastener sealing material wicks on to a portion of a shank of the fastener.

18. The fastener sealing material of claim 1 wherein when applied to a fastener, the fastener sealing material forms a locking material for the fastener.

19. A method of making a fastener with a sealing material thereon, comprising:
applying a liquid applied acrylate material to the fastener; and
curing the liquid applied acrylate material using an ultraviolet or LED light source and without the use of heat.

20. The method of claim 19 including the step of pretreating the fastener with a plasma treatment.
